(19) United States
(12) Patent Application Publication
(10) Pub. No.: US 2004/0241287 A1
(43) Pub. Date: Dec. 2, 2004

(54) Moisture barrier in food

(76) Inventors: Johannes Adrianus Henricus Petrus Bastiaans, Amersfoort (NL); Wilhelmus Hendricus Johannes Tap, Wijchen (NL); Maria Petronella Johanna Martina Bouwman-Timmermans, Apeldoorn (NL); Jan Willem Manenschijn, Holten (NL)

Correspondence Address: HELLER EHRMAN WHITE & MCAULIFFE LLP, 275 MIDDLEFIELD ROAD, MENLO PARK, CA, 94025-3506, US

(21) Appl. No.: 10/484,651

(22) PCT Filed: Jul. 19, 2002
(86) PCT No.: PCT/NL02/00488

(30) Foreign Application Priority Data
Jul. 20, 2001 (NL) 1018607

(51) Int. Cl. A23L 1/00

(52) U.S. Cl. 426/89

(57) ABSTRACT

The moisture-sensitive core of a coated food ingredient, for example consisting of pasta, chocolate, cereals, fruit or nuts, in a water-containing environment, such as a dairy product, can be protected against ingress of moisture and loss of crispness by a moisture-resistant coating of a continuous fat layer in which 1-15% (m/m) water-insoluble and fat-insoluble particles having an average particle diameter of 1-100 μm are present. The particles are in particular inorganic, for example consisting of silicon dioxide.

The invention relates to a coated food ingredient which by virtue of the coating retains its crispness even at temperatures above 0° C. in an aqueous environment.

The migration of moisture between ingredients of differing hygroscopicity has long been a problem in foods because the migration of moisture severely reduces the quality and shelf life of the food. The problem arises in particular in foods in which one of the ingredients has characteristics such as taste, crispness or crunchiness which are adversely affected by water. The solution to this problem is usually sought in applying a moisture barrier to the ingredient that has to be protected against moisture. Hydrophobic substances such as oils and fats, optionally in the form of chocolate, acetylated monoglycerides, shellac, natural waxes and zeins, are widely used as the barrier material. The barrier characteristics of such materials are, however, not always adequate or sufficiently stable and sometimes there are also problems with regard to taste.

In WO 97/15198 a composite food that keeps well at 5° C. is described in which a moisture barrier has been applied between a water-based food ingredient, such as soft curd cheese, and a fat-based food ingredient, such as chocolate. The moisture barrier consists of 50-70% fat and 30-50% lactose and serves to restrict transport of water from the aqueous layer to the fat layer in the food.

According to EP 1 036 507 the outer coating of a deep-frozen snack, such as a croquette, can be kept crunchy when the snack is heated in a microwave by means of an intermediate coating of emulsified protein and fat that is applied on top of a moisture-absorbent such as silicon dioxide.

U.S. Pat. No. 4,603,051 describes an edible food container such as an ice cream cone internally coated with a fat layer as a moisture-resistant barrier. The fat layer contains 2,5-10% of an inert filler such as starch or dextrin. Although the filler appears to improve the blocking and cracking of the container in air, leaking time of a water-filled container is not improved by the filler, or is even deteriorated. The patent also mentions other possible filler materials such as talc, titanium dioxide, silica, but without any illustration of their utility.

In EP 0 664 959 chocolate pieces and chocolate coatings are described which consist of at least 70% cocoa butter or a fat substitute for cocoa butter and also sugar and cocoa pieces. The fat composition must ensure that the pieces, or the coated pieces, do not soften but remain crispy in a non-frozen aqueous environment such as a diary product.

However, it has been found that known moisture barriers of this type are not adequately able to withstand an aqueous environment such as that of dairy products and that the barrier characteristics thereof are also not constant. Moreover, it is difficult to apply such materials to irregularly shaped, moisture-sensitive food ingredients such as nuts and cake in such a way that the barrier is uniformly and thus effectively distributed. For thicker coatings or solid pieces the fat content is usually too high, as a result of which the taste is adversely affected.

A coating material has now been found with which these problems are solved. The coating material according to the invention consists of a continuous fat layer that contains 1-15% (m/m) water-insoluble and fat-insoluble particles having an average particle diameter of 0.05-100 μm. It is found that the moisture-resistant properties of a fat-based coating are surprisingly improved by the addition of such inert particles, such that crispy pieces retain their crispness even in a chilled, but not frozen, aqueous environment for a prolonged period, that is to say four weeks or more.

The continuous fat layer in the coating according to the invention consists of fats which are partially crystalline at low temperatures (0-15° C.), that is to say have a solid fat content of at least 30%, preferably at least 50%, at 10° C. Because of the taste of the fat, the melting point of the fat must be no higher than 37° C., that is to say at that temperature the fat must have a solid fat content of less than 10%, preferably less than 5%. Fats such as milk fat, coconut fat (optionally hardened) and cocoa butter have been found to be suitable. The composition of the coating preferably consists to at least 60% to approximately 99%, in particular 65-80% of the said fat. The remainder can consist of another water-insoluble material, cocoa powder, odour substances, flavourings and colourings. For natural compositions, in particular in the case of thin layers, the fat content can advantageously be 90-98%. The thickness of the fat layer can vary with the nature of the food. Usually a thickness of 100 μm to 5 mm, in particular 0.5-3 mm, will be appropriate. In the case of thin layers, for example 100 μm-500 μm, the percentage of insoluble particles in the fat layer is preferably somewhat higher, at least 2%, preferably 3-15%, and the average particle size is somewhat lower, preferably 0.05-30 μm. The fat layer does not contain substantial amounts of sugars or other water-soluble compounds: the sugar content is preferably below 5%, most preferably below 1%. Also, the fat layer does not contain substantial amounts of the moisture-sensitive ingredients: i.e. the fat phase is coated on, but not mixed with the ingredient.

The particles in the continuous fat layer are insoluble in water and insoluble in fat. The particles must be harmless from the nutritional standpoint. They increase the viscosity of the oil, that is to say of the fat in the molten state and evidently change the physical properties in such a way that the water-occluding action is improved, possibly by reducing the risk of cracks and a greater flexibility of the layer. Examples are inorganic substances such as silicon dioxide, single silicates, such as sodium silicate, calcium silicate and magnesium silicate, aluminium silicate, magnesium trisilicate, composite silicates such as sodium aluminium silicate, potassium aluminium silicate and calcium aluminium silicate, talc, clay materials such as bentonite, carbon, insoluble carbonates and phosphates such as calcium carbonate and magnesium carbonate and calcium phosphate. In addition, some organic materials such as microcrystalline cellulose and insoluble cellulose derivatives can also be used. The preference is for silicon oxide, the form of which is not critical. The particle size is such that the continuity of the fat layer is not disrupted. In general, the average particle size must be no greater than 100 μm, preferably less than 50 μm and in particular less than 30 μm. The minimum particle size is approximately 0.05 μm; preferably the average particle diameter is at least 0.1 μm. Suitable types of silicon dioxide are commercially available. Examples of these are Neosyl TS® (Crossfield, GB, 10-12 μm), Cab-O-Sil M5® (Cabot, Del., 0.2-0.3 μm) and Zerofree 5161 (Huber, DK, 100 μm).

The coated ingredient is in general a food material that is moisture-sensitive, or the moisture content of which or the water-soluble ingredients content of which is adversely affected by moisture migration. The ingredients are frequently crispy or crunchy ingredients with a low water content, with a hygroscopicity of less than 0.6. These can be dried, baked or deep-fried products. The ingredients can also be moisture-containing materials where the integrity or the organoleptic properties are adversely affected by exchange of moisture. Examples are nuts, cereals, pasta products, other cooked doughs, chocolate, fruit, which may or may not be dried, vegetables, potato products (crisps), etc. with dimensions of the order of 2 mm to 2 cm. The amount of coating material applied is in general 0.01-5 g per cm³ coated ingredient, in particular 0.02-2.5 g per cm³. For ingredients with a relatively high density, such as nuts and the like, this amounts to approximately 0.01-1.0 g per g and for ingredients with a relatively low (apparent) density, such as cake, crunchy muesli and the like, this will be approximately 0.1-5 g per g.

The fat composition containing insoluble particles according to the invention can also be used to prevent the transport of water between two or more layers in a packaged food, for example a layer of chocolate and a water-containing layer. The separating layer can be, for example, 100 μm to 5 mm thick. Solid (homogeneous) particles consisting of the fat composition as described above for the coating material, which, by virtue of the presence of 1-15% insoluble solid, in particular silicon dioxide, are protected against softening and losing crispness, are also part of the invention. Here the particles can be, for example, chocolate pieces or other fat-rich particles with a diameter of 2 mm to 1 cm in a dairy product or drink.

The aqueous environment is in general a food ingredient with a high water content and a hygroscopicity of at least 0.85, such as drinks, sauces, soups, cakes, pastries, snacks and in particular dairy products such as yoghurt, custard, soft curd cheese, cheese, ice-cream mixes and the like. Such foods are usually stored cool (4-7° C.); the products can optionally also be stored frozen. The product is conveniently packed in a container of suitable size varying from e.g. 100 cm³ to 10 dm³ and made of a suitable material such as plastic, glass, coated board or paper, coated metal etc.

The coating material can be applied by any coating process known in food technology, such as immersion, sugar coating, i.e. rolling in a fluidised bed, spraying or stirring, at a temperature such that the fat is deformable and preferably molten and is able to solidify rapidly after application.

Immersion of particles in a coating fluid is a technique that is widely used in the confectionary industry and does not require any special equipment. The layer thickness is determined by the viscosity of the coating material and/or by the rate at which this changes (solidifies) after application. In the case of spraying the coating fluid can be applied via nozzles to diverse substrates. With this procedure the substrates can be kept fluidised and mixed with a mixer. It must be possible to atomise the coating fluid with this procedure. Sugar coating is another technique that is widely used in the confectionary industry and is carried out with the aid of a sugar-coating mill. In the case of sugar coating a centre is coated with, for example, a layer of sugar and/or chocolate. In other words, dragée products are made by applying a layer on layer coating, to centres which are rotating in a sugar-coating mill. A smooth, regular and closed surface of coating material is obtained by mutual rotation of centres in a rotating sugar-coating mill.

### EXAMPLE 1

Round biscuit pieces were coated with a mixture of 74% cocoa butter, 22.5% cocoa powder and 3.5% silicon oxide in a sugar-coating kettle (diameter of the bowl approximately 25 cm, diameter of the opening approximately 18 cm, bowl placed at an angle of approximately 45°). The kettle was filled with 400 g (1.14 l) biscuits. Coating material was introduced into the sugar-coating kettle in 10 g portions at a temperature of 40° C. (shear rate 10 s⁻¹:0.276, shear rate 100 s⁻¹:0.201). Cooling was effected by air cooling. The final weight of the pieces was 904.5 g (the calculated average layer thickness was 1.29 mm). Subsequently some of the coated pieces were mixed with full fat yoghurt and some were mixed with white custard (8 pieces per 200 ml in each case) and stored cool. The crispness of the coated biscuit pieces was assessed organoleptically after 1 to 28 days. The results are given in Table 1 below. It can be seen from this table that of the total number of pieces that were treated with the coating containing silicon oxide 15 of the 16 (94%) were still crisp. When a coating without silicon oxide was used, all pieces were completely soft after 21 days.

TABLE 1
Assessment results

| | |
|---|---|
| Yoghurt | White custard |

| Number of days | % crisp | % soft | % crisp | % soft |
|---|---|---|---|---|
| 1 | 100 | 0 | 100 | 0 |
| 3 | 100 | 0 | 100 | 0 |
| 7 | 100 | 0 | 100 | 0 |
| 14 | 88 | 12 | 100 | 0 |
| 21 | 100 | 0 | 88 | 12 |
| 28 | 100 | 0 | — | — |

### EXAMPLE 2

Round biscuit pieces were coated with Mixture 1 (74% cocoa butter, 22.5% cocoa powder, 3.5% silicon oxide) in a sugar-coating kettle (diameter of the bowl approximately 100 cm, diameter of the opening approximately 60 cm; the bowl was placed at an angle of approximately 45°). As a reference, identical biscuit pieces were coated with Mixture 2 (76.7% cocoa butter, 23.3% cocoa powder). The kettle was filled with 14 kg (40 litres) biscuits. The coating material was sprayed into the sugar-coating kettle at a temperature of 40° C. Cooling was effected by blowing air at approximately 15° C. into the kettle. The final weight of the pieces was 23 kg (quantity of coating material applied 9 kg). The two mixtures were applied to the biscuit pieces in comparable quantities (a coated piece consists of 40% Mixture 1 or 2).

The coated pieces were then mixed into full fat yoghurt or yellow custard (“vla”) (10 pieces per 200 ml) and stored cool. The crispness of the coated biscuit pieces was assessed organoleptically over time after 1, 3, 7, 14, 21 and 28 days (see table below for results). 95% of the pieces coated with Mixture 1, the coating containing silicon oxide, were crisp after 28 days. Only 70% of the pieces coated with Mixture 2, coating without silicon oxide, were crisp after 28 days.

TABLE 2
Assessment results

| | |
|---|---|
| Coating Mixture 1 | Coating Mixture 2 |

| Number of days | % crisp | % soft | % crisp | % soft |
|---|---|---|---|---|
| 7 | 95 | 5 | 75 | 25 |
| 14 | 100 | 0 | 85 | 15 |
| 21 | 90 | 10 | 76 | 24 |
| 28 | 95 | 5 | 70 | 30 |

The coated pieces were also placed in a glass beaker containing water (50 pieces per litre) and stored cool. The coated biscuit pieces were assessed for buoyancy over time after 7, 14, 21 and 28 days; leaking and soft pieces sink to the bottom (see table below for results). 94% of the pieces coated with Mixture 1, the coating containing silicon oxide, were still crisp after 28 days. Only 78% of the pieces coated with Mixture 2, coating without silicon oxide, were crisp after 28 days.

TABLE 3
Assessment results

| | |
|---|---|
| Coating Mixture 1 | Coating Mixture 2 |

| Number of days | % crisp | % soft | % crisp | % soft |
|---|---|---|---|---|
| 14 | 98 | 2 | 88 | 12 |
| 21 | 94 | 6 | 84 | 16 |
| 28 | 94 | 6 | 78 | 22 |

### EXAMPLE 3

Round biscuit pieces were coated with Mixture 1 (94% coconut fat: Coldcup Special, Vandermoortele, BE, 6% silicon oxide) in a sugar-coating kettle (diameter of the bowl approximately 25 cm, diameter of the opening approximately 18 cm; the bowl was placed at an angle of approximately 45°). As a reference, identical biscuit pieces were coated with 100% coconut fat (Mixture 2). The kettle was filled with 470 g (1.34 litre) biscuits. The coating material was introduced into the sugar-coating kettle in 10 gram portions and at a temperature of 60° C. Cooling was effected manually by switching a fan positioned in front of the bowl on and off. The final weight of the pieces was 870 gram (quantity of coating material applied 400 gram). The coated pieces were then mixed into full fat yoghurt or custard (8 pieces per 200 ml) and stored cool. The crispness of the coated biscuit pieces was assessed organoleptically after 7, 14 and 21 days (see Table 4 for result). 100% of the pieces coated with the coating containing silicon oxide were still crisp after 21 days. A variant with pure coconut fat as the coating gave 12% pieces that had become soft after 21 days.

TABLE 4
Assessment results

| | |
|---|---|
| Coating Mixture 1 | Coating Mixture 2 |

| Number of days | % crisp | % soft | % crisp | % soft |
|---|---|---|---|---|
| 7 | 100 | 0 | 93 | 7 |
| 14 | 100 | 0 | 95 | 5 |
| 21 | 100 | 0 | 88 | 12 |

### EXAMPLE 4

Round biscuit pieces were coated with Mixture 1 (94% cocoa butter: Astra A, type F from ADM Cocoa, and 6% silicon oxide) following the procedure of example 2. As a reference, identical biscuit pieces were coated with 100% of the same cocoa butter (Mixture 2).

The coated pieces were then mixed into full fat yoghurt or yellow custard and assessed organoleptically as described in example 2. The results are given in Table 5. The pieces coated with Mixture 1 were still 100% crisp after 28 days, whereas only 20% of the pieces coated with Mixture 2 were crisp after 28 days.

TABLE 5
Assessment results

| | Coating Mixture 1 | | Coating Mixture 2 | |
|---|---|---|---|---|
| | % crisp in | % crisp in | % crisp in | % crisp in |
| Number of days | custard | yoghurt | custard | yoghurt |
| 3 | 100 | 100 | 60 | 60 |
| 7 | 100 | 100 | 10 | 30 |
| 14 | 90 | 100 | 30 | 20 |
| 21 | 90 | 90 | 60 | 30 |
| 28 | 100 | 100 | 20 | 20 |

1-11. (canceled).

12. A composite food comprising a particulate moisture-sensitive food ingredient selected from the group consisting of nuts, cereals, fruits, vegetable, chocolate, pasta and mixtures thereof, in a water-containing edible or drinkable medium, the ingredient being coated with a continuous fat phase in which 1-15% (m/m) water-insoluble and fat-insoluble particles having an average particle diameter of 0.05-100 μm are present.

13. The composite food of claim 12, wherein the insoluble particles comprise silicon dioxide, single or composite silicates or cellulose.

14. The composite food of claim 12, wherein the insoluble particles comprise silicon dioxide.

15. The composite food of claim 12, wherein the insoluble particles have an average particle diameter of 1-30 μm.

16. The composite food of claim 13, wherein the insoluble particles have an average particle diameter of 1-30 μm.

17. The composite food of claim 12, wherein the fat phase contains 3-10% (m/m) insoluble particles.

18. The composite food of claim 13, wherein the fat phase contains 3-10% (m/m) insoluble particles.

19. The composite food of claim 15, wherein the fat phase contains 3-10% (m/m) insoluble particles.

20. The composite food of claim 16, wherein the fat phase contains 3-10% (m/m) insoluble particles.

21. The composite food of claim 12, wherein the fat phase is a coating having a thickness of 0.1-5 mm around a moisture-sensitive core of the food ingredient.

22. The composite food of claim 13, wherein the fat phase is a coating having a thickness of 0.1-5 mm around a moisture-sensitive core of the food ingredient.

23. The composite food of claim 14, wherein the fat phase is a coating having a thickness of 0.1-5 mm around a moisture-sensitive core of the food ingredient.

24. The composite food of claim 15, wherein the fat phase is a coating having a thickness of 0.1-5 mm around a moisture-sensitive core of the food ingredient.

25. The composite food of claim 16, wherein the fat phase is a coating having a thickness of 0.1-5 mm around a moisture-sensitive core of the food ingredient.

26. The composite food of claim 17, wherein the fat phase is a coating having a thickness of 0.1-5 mm around a moisture-sensitive core of the food ingredient.

27. The composite food of claim 18, wherein the fat phase is a coating having a thickness of 0.1-5 mm around a moisture-sensitive core of the food ingredient.

28. The composite food of claim 19, wherein the fat phase is a coating having a thickness of 0.1-5 mm around a moisture-sensitive core of the food ingredient.

29. The composite food of claim 12, wherein the edible or drinkable medium is a dairy product.

30. The composite food of claim 13, wherein the edible or drinkable medium is a dairy product.

31. The composite food of claim 15, wherein the edible or drinkable medium is a dairy product.

32. The composite food of claim 16, wherein the edible or drinkable medium is a dairy product.

33. The composite food of claim 17, wherein the edible or drinkable medium is a dairy product.

34. The composite food of claim 18, wherein the edible or drinkable medium is a dairy product.

35. The composite food of claim 21, wherein the edible or drinkable medium is a dairy product.

36. The composite food of claim 22, wherein the edible or drinkable medium is a dairy product.

37. The composite food of claim 12, which is packed in a container.

38. The composite food of claim 13, which is packed in a container.

39. The composite food of claim 15, which is packed in a container.

40. The composite food of claim 17, which is packed in a container.

41. The composite food of claim 21, which is packed in a container.

42. The composite food of claim 29, which is packed in a container.

43. A process for coating a food ingredient selected from the group consisting of nuts, cereals, fruits, vegetables, chocolate, pasta and mixtures thereof, comprising applying a dispersion of 1-15% (m/m) water-insoluble and fat-insoluble particles having an average particle diameter of 0.05-100 μm in a fat to the food ingredient at a temperature above the melting point of the fat.

44. A coated food component consisting of a moisture-sensitive food-containing core selected from the group consisting of nuts, cereals, fruits, vegetables, chocolate, pasta and mixtures thereof, and a moisture-resistant coating having a thickness of 0.1-5 mm, the coating containing 1-15 wt % of silica or silicates having an average particle diameter of 0.05-100 μm, the coating not containing the moisture-sensitive food.

45. The coated food component of claim 44, wherein the coating contains 3-10 wt % of silica or silicates.
